(19) United States
(12) Patent Application Publication
(10) Pub. No.: US 2006/0116030 A1
(43) Pub. Date: Jun. 1, 2006

(54) Remote unit, remote system, extender, and automatic adjusting method

(75) Inventors: Tetsuya Niiyama, Shinagawa (JP); Fujio Seki, Shinagawa (JP); Heiichi Sugino, Shinagawa (JP)

Correspondence Address: STAAS & HALSEY LLP, SUITE 700, 1201 NEW YORK AVENUE, N.W., WASHINGTON, DC, 20005, US

(73) Assignee: FUJITSU COMPONENT LIMITED, Tokyo (JP)

(21) Appl. No.: 11/282,668

(22) Filed: Nov. 21, 2005

(30) Foreign Application Priority Data
Nov. 26, 2004 (JP) 2004-341960
Jan. 12, 2005 (JP) 2005-005782

(51) Int. Cl. H01R 13/73

(52) U.S. Cl. 439/894

(57) ABSTRACT

A remote unit that is connected to a server with a cable, and receives and displays an image signal transmitted from the server, the remote unit includes a receiving portion that receives a signal transmitted via the cable and adjusts a gain of the signal, a voltage detection portion that receives an automatic adjusting signal for adjusting the gain and detects a received voltage of the signal, and a control portion that obtains a length of the cable with the received voltage and adjusts the gain of the receiving portion with the length obtained.

### BACKGROUND OF THE INVENTION

1. Field of the Invention

This invention generally relates to remote units, remote systems, and automatic adjusting methods, and more particularly, to a remote unit, remote system, extender, and automatic adjusting method to operate a server provided at a remote location with the use of a monitor, keyboard, mouse, and the like.

2. Description of the Related Art

These years, the technique of operating the server or the like located remotely has been attracting attention, even if the user is more than several hundred meters away from the server. To utilize this technique, the server provided at a remote location has to be connected to the display device and keyboard on the user's side by some means. Conventionally, there has been provided an intermediate node having remote units for sending and receiving ends between the server and the display device and the like, and further provided a LAN (Local Area Network) cable to connect therebetween.

On the afore-mentioned remote unit, three kinds of image signals for RGB are transmitted with multiple signal lines to display images on the display device. However, as the cable becomes longer to connect the remote units for sending and receiving ends, the signals become out of alignment according to the difference in the length of the cables respectively provided for R, G, and B. The fluctuation of the signal delay time causes the color drift and degrades the sharpness of the characters displayed on the display device.

Japanese Patent Application Publication No. 63-133777 (hereinafter, referred to as Document 1) describes a switch provided for the digital address display. The digital video signal, horizontal synchronizing digital signal, and vertical synchronizing digital signal are respectively transmitted on the respective cables. The switch corrects the difference in the delay between the cables.

It is to be noted that as the cable becomes longer for connecting the remote units for sending and receiving ends, skew occurs between the image signals and the image signals are attenuated. The sharpness of the characters is decreased depending on the attenuation or skew of the image signal, causing the color drift of character. In particular, recent display devices make progress in high resolution. Therefore, the higher frequency of the image signal and the longer length of the cable significantly attenuate the signal. Document 1 also describes the configuration in which the switch is manually changed to correct the delay. This is somewhat time-consuming.

### SUMMARY OF THE INVENTION

The present invention has been made in view of the above circumstances and provides a remote unit, remote system, extender, and automatic adjusting method, with which high-quality images that have been received can be displayed on a monitor.

According to one aspect of the present invention, preferably, there is provided a remote unit that is connected to a server with a cable, and receives and displays an image signal transmitted from the server, the remote unit including a receiving portion that receives a signal transmitted via the cable and adjusts a gain of the signal; a voltage detection portion that receives an automatic adjusting signal for adjusting the gain and detects a received voltage of the signal; and a control portion that obtains a length of the cable with the received voltage and adjusts the gain of the receiving portion with the length obtained. Therefore, according to the length of the cable, it is possible to adjust the gain of the receiving portion optimally, and this makes it possible to display the high-quality image that has been received on a monitor.

According to another aspect of the present invention, preferably, there is provided a remote unit that is connected to a server with a cable, and receives and displays an image signal transmitted from the server, the remote unit including a receiving portion that receives a signal transmitted via the cable and adjusts a frequency characteristic of the signal; a voltage detection portion that receives an automatic adjusting signal for adjusting the frequency characteristic and detects a received voltage of the signal; and a control portion that obtains a length of the cable with the received voltage and controls the receiving portion to obtain the frequency characteristic that is desirable. Therefore, according to the length of the cable, it is possible to adjust the frequency characteristic of the receiving portion optimally, and thereby it is possible to display the high-quality image that has been received on a monitor.

According to another aspect of the present invention, preferably, there is provided a remote unit that is connected to a server with a cable, and receives and displays an image signal transmitted from the server, the remote unit including a receiving portion that receives signals of multiple signal lines included in the cable; a delay time measuring portion that measures a delay time between the signals of said multiple signal lines; and a signal delay portion that delays and outputs a corresponding signal according to the delay time. Therefore, according to the length of the cable, it is possible to correct the delay times between multiple signal lines, and it is therefore possible to display the high-quality image without a color drift on a monitor.

According to another aspect of the present invention, preferably, there is provided a remote system including a transmitting device that outputs an image signal output from a server to a cable; and a receiving device that is connected to the transmitting device via the cable and receives the image signal. The transmitting device may include a transmitting portion that outputs an automatic adjusting signal for adjusting a gain. The receiving device may include a receiving portion that receives a signal transmitted via the cable and adjusts the gain of the signal; a voltage detection portion that detects a received voltage of the automatic adjusting signal; and a control portion that obtains a length of the cable with the received voltage and adjusts the gain of the receiving portion with the length obtained.

According to another aspect of the present invention, preferably, there is provided a remote system including a transmitting device that outputs an image signal output from a server to a cable; and a receiving device that is connected to the transmitting device via the cable and receives the image signal. The transmitting device may include a transmitting portion that outputs an automatic adjusting signal for adjusting a frequency characteristic. The receiving device may include a receiving portion that receives a signal transmitted via the cable and adjusts the frequency characteristic of the signal; a voltage detection portion that detects a received voltage of the automatic adjusting signal; and a control portion that obtains a length of the cable with the received voltage and adjusts the gain of the receiving portion with the length obtained.

According to another aspect of the present invention, preferably, there is provided a remote system including a transmitting device that outputs an image signal output from a server to a cable; and a receiving device that is connected to the transmitting device via the cable and receives the image signal. The receiving device may include a receiving portion that receives signals transmitted on multiple signal lines included in the cable; a delay time measuring portion that measures a delay time between the signals of said multiple signal lines; and a signal delay portion that delays and outputs a corresponding signal according to the delay time. It is possible to restore the attenuated signal and relay the signal to a device in a later stage, and thereby it is possible to extend the transmission distance of the signal.

According to another aspect of the present invention, preferably, there is provided an extender provided on a transmission line to relay a signal, the extender including a receiving portion that receives the signal and adjusts a gain of the signal; a voltage detection portion that detects a received voltage of an automatic adjusting signal for adjusting the gain; and a control portion that obtains a length of the cable with the received voltage and adjusts the gain of the receiving portion with the length of the cable obtained.

According to another aspect of the present invention, preferably, there is provided an extender provided on a transmission line to relay a signal, the extender including a receiving portion that receives the signal and adjusts a frequency characteristic of the signal; a voltage detection portion that detects a received voltage of an automatic adjusting signal for adjusting the frequency characteristic; and a control portion that measures a length of the cable with the received voltage, controls the receiving portion according to the length of the cable obtained, and obtains the frequency characteristic that is desirable.

According to another aspect of the present invention, preferably, there is provided an extender provided on a transmission line to relay a signal, the extender including a receiving portion that receives signals of multiple signal lines included in a cable; a delay time measuring portion that measures a delay time between the signals of said multiple signal lines; and a signal delay portion that delays and outputs a corresponding signal according to the delay time.

According to another aspect of the present invention, preferably, there is provided a remote system including the above-mentioned transmitting device; the above-mentioned receiving device; and the above-mentioned extender provided on a transmission line to relay a signal.

According to another aspect of the present invention, preferably, there is provided an automatic adjusting method including receiving on a receiving portion an automatic adjusting signal transmitted on a cable; detecting a received voltage of the automatic adjusting signal received via the cable; and measuring a length of the cable with the received voltage and adjusting a gain of the receiving portion on the basis of the length of the cable measured.

According to another aspect of the present invention, preferably, there is provided an automatic adjusting method including receiving on a receiving portion an automatic adjusting signal transmitted on a cable; detecting a received voltage of the automatic adjusting signal received via the cable; and measuring a length of the cable with the received voltage and controlling the receiving portion to obtain a desired frequency characteristic on the basis of the length of the cable measured.

According to another aspect of the present invention, preferably, there is provided an automatic adjusting method including receiving signals transmitted on multiple signal lines; measuring delay times between the signals transmitted on said multiple signal lines; and delaying and outputting a corresponding signal according to the delay times.

### BRIEF DESCRIPTION OF THE DRAWINGS

Preferred embodiments of the present invention will be described in detail with reference to the following drawings, wherein:

FIG. 1 is a view showing a configuration of a remote system;

FIG. 2 is a view showing a transmitting device 10 and a receiving device 20;

FIG. 3 is a view showing a configuration of a gain adjusting table;

FIG. 4 is a view illustrating a gain adjustment;

FIG. 5 is a view showing a configuration of a frequency characteristic adjusting table;

FIG. 6 is a view illustrating a frequency characteristic adjustment;

FIG. 7 is a view showing a configuration of a skew measuring circuit;

FIG. 8 shows signal waveforms for illustrating an operation of the skew measuring circuit;

FIG. 9 is a view showing a configuration of a delay circuit 23;

FIG. 10 is a view showing a transmission line serving as a reference and a delay setting of other transmission lines;

FIG. 11 is a view showing signals before and after skew adjustment;

FIG. 12 is a flowchart showing an operation procedure in test mode;

FIG. 13 is a flowchart showing the operation procedure in manual adjustment;

FIG. 14 is a view showing a semiconductor chip mounted on a substrate and signal patterns thereon;

FIG. 15 is a view showing a configuration in accordance with a second embodiment;

FIG. 16 is a block diagram showing a configuration of an extender;

FIG. 17 shows an input signal waveform, input and output waveforms of the extender, and an input signal waveform of the receiving device;

FIG. 18 is a block diagram showing another configuration of the extender; and

FIG. 19 is a flowchart showing an operation procedure.

### DESCRIPTION OF THE PREFERRED EMBODIMENTS

A description will now be given, with reference to the accompanying drawings, of embodiments of the present invention.

### First Embodiment

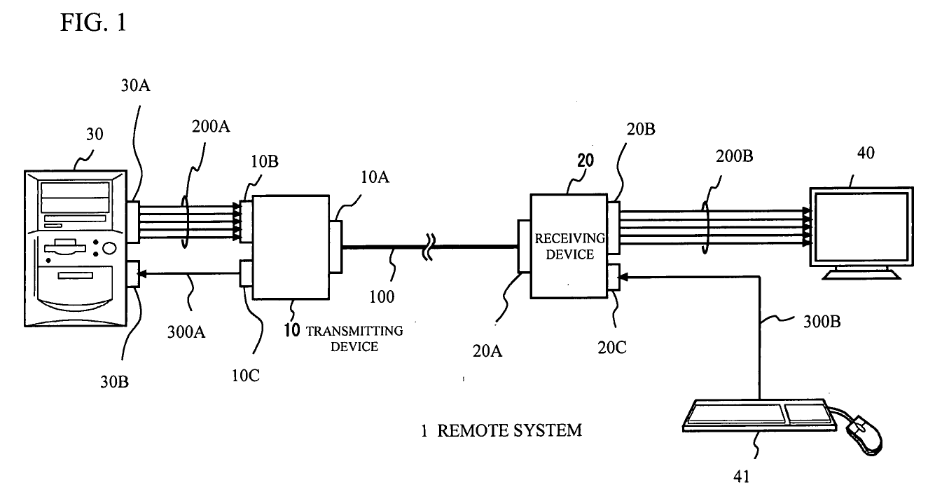

A description will be given of a first embodiment of the present invention, with reference to FIG. 1. A remote system in FIG. 1 includes a transmitting device 10 and a receiving device 20 serving as remote units, which are provided between a server 30 and a display 40, keyboard, mouse, or the like (hereinafter, referred to as keyboard/mouse) 41.

The transmitting device 10 and the receiving device 20 are connected to a LAN cable 100 so that the transmitting device 10 and the receiving device 20 can send and receive data. To realize the afore-mentioned capabilities, the transmitting device 10 and the receiving device 20 respectively include network interfaces 10A and 20A. Hereinafter, the interface is referred to as I/F. Straight-through Category 5 E cable or the like, for instance, may be used for the LAN cable 100. Preferably, the cable is terminated by the R-J 45 connector. This is a connector commonly used for a general LAN system. This allows the user to use an easy-obtainable cable. The network I/F 10A and 20A do not define the physical layer of the OSI model. Any type of interface may be applicable, if the interface is capable of sending and receiving three image signals (for R, G, and B), horizontal synchronizing signal HSYNC, vertical synchronizing signal VSYNC, and a signal input from the keyboard/mouse 41. Hereinafter, an image signal simply denotes any one of the three image signals of R, G, and B. Synchronizing signal denotes any one of the horizontal synchronizing signal HSYNC and vertical synchronizing signal VSYNC. Operation signal denotes the signal input from the keyboard/mouse 41.

The transmitting device 10 includes a VGA (Video Graphics Array) connector 10B, which is a display connector. The image signal (RGB), the horizontal synchronizing signal, and the vertical synchronizing signal are applied to the VGA connector 10B from the server 30 composed of a personal computer, work station, or another information processing apparatus. The VGA connector 10B may employ a commonly used connector such as a BNC connector, D-sub 15 pin connector, or the like.

The transmitting device 10 includes a keyboard/mouse connector 10C that inputs the operation signal of the keyboard/mouse 41 into the server 30 via the receiving device 20. The keyboard/mouse connector 10C may employ a connector commonly used for connecting the keyboard and mouse such as a PS/2 connector, USB (Universal Serial Bus) connector, or another serial connector.

The server 30 includes a VGA connector 30A and a keyboard/mouse connector 30B, which are also included in a commonly used information processing apparatus. The VGA connector 30A is provided for outputting the image signal (RGB) and the keyboard/mouse connector 30B is provided for inputting the operation signal applied from the keyboard or the mouse. Accordingly, the VGA connector 10B provided on a surface of a chassis of the transmitting device 10 is connected to the VGA connector 30A provided on the surface of the chassis of the server 30 via an RGB cable 200A composed of such as a BNC cable, D-sub 15 pin cable, or the like, for example. In the same manner, the keyboard/mouse connector 10C provided on the surface of the chassis of the transmitting device 10 is connected to the keyboard/mouse connector 30B provided on the surface of the chassis of the server 30 via a cable 300A, which is used for connecting a commonly used keyboard and mouse, such as a PS/2 cable, USB cable, or another serial cable.

The receiving device 20 includes a VGA (Video Graphic Array) connector 20B as a display connector. The VGA connector 20B may employ a commonly used connector such as a BNC connector, D-sub 15 pin connector, or the like. The VGA connector 20B is connected to an RGB cable 200B provided on the display 40. The RGB cable 200B is also composed of the BNC cable, D-sub 15 pin cable, or the like, for example.

The receiving device 20 also includes a keyboard/mouse connector 20C so that the operation signal may be input from the keyboard/mouse 41. The keyboard/mouse connector 20C may employ a commonly used connector for connecting the keyboard and mouse such as a PS/2 connector, USB connector, or another serial connector. The keyboard/mouse connector 20C is connected to a cable 300B provided on the keyboard/mouse 41. The cable 300B is also composed of a commonly used cable for connecting the keyboard and the mouse, such as a PS/2 cable, USB cable, or another serial cable. The receiving device 20 shown in FIG. 1 includes a driver circuit, into which operation information of the keyboard/mouse 41 is input and then output to the LAN cable 100. In the same manner, the transmitting device 10 includes a receiver that receives the operation information to be received via the LAN cable 100, and such received operation information is output to the server 30 via the cable 300A.

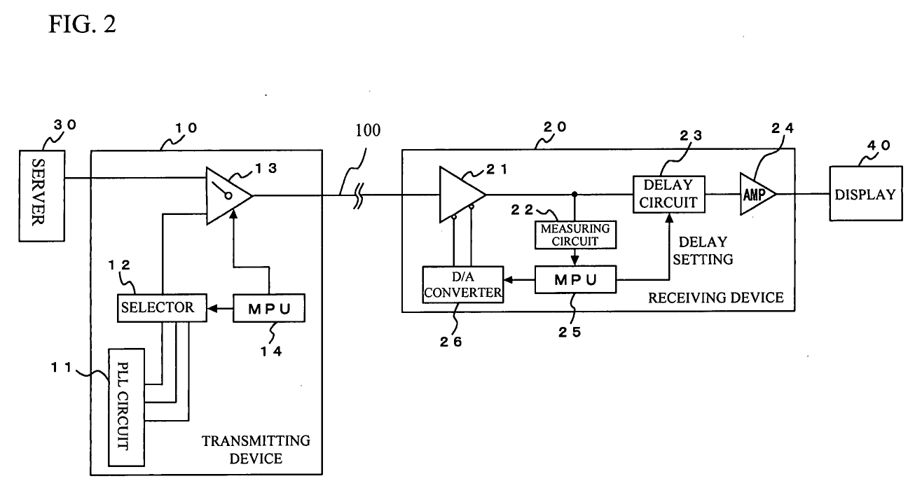

A description will now be given of an internal configuration of the transmitting device 10 and the receiving device 20. Referring to FIG. 2, the transmitting device 10 in accordance with the present embodiment of the present invention includes a PLL (Phase Locked Loop) circuit 11, a selector 12, a driver 13, and an MPU (Micro Processing Unit) 14.

The PLL circuit 11 generates an automatic adjusting signal on the receiving device 20 to adjust the difference or deviation of gain, frequency characteristic, and signal delay time. In the present embodiment, 14 MHz and 90 MHz automatic adjusting signals are used for adjusting the frequency characteristic. 1 MHz signal is used for adjusting the gain. Any one of 1 MHz, 14 MHz, and 90 MHz automatic adjusting signals may be used for measuring the delay time of the RGB image signal occurring on the transmission line.

The MPU 14 outputs any of the automatic adjusting signals generated on the PLL circuit 11 to the LAN cable 100 according to an instruction of an MPU 25 provided on the receiving device 20, with the use of the driver 13. That is to say, the MPU 14 controls the selector 12 and selectively changes the automatic adjusting signal to be output to the driver 13. The MPU 14 controls the driver 13 and outputs the image signal or the automatic adjusting signal to the LAN cable 100. The MPU 14 on the transmitting device 10 and the MPU 25 on the receiving device 20 are connected by a control signal, not shown.

Now, a description will be given of a configuration of the receiving device 20. The receiving device 20, as shown in FIG. 2, includes a receiver 21, a measuring circuit 22, a delay circuit 23 provided on a signal transmission line, an amplifier 24, the MPU 25, and a D/A converter 26.

The receiver 21 receives the signal transmitted from the transmitting device 10, and includes an equalizer that adjusts the frequency characteristic of the transmitted signal. The receiver 21 also includes a gain control terminal and a frequency characteristic adjusting terminal. The gain of the receiver 21 can be adjusted by changing the voltage supplied to the gain control terminal. The frequency characteristic can be adjusted by changing the voltage supplied to the frequency characteristic adjusting terminal. The voltages supplied to the afore-mentioned terminals are supplied from the D/A converter 26 by the control of the MPU 25.

The measuring circuit 22 includes a voltage detection circuit that measures an attenuation amount of the automatic adjusting signal transmitted from the transmitting device 10. The measuring circuit 22 also includes a skew measuring circuit 50 that measures the delay time of the RGB image signal generated on the transmission line. The skew measuring circuit 50 will be described later.

The delay circuit 23 delays the signals on the respective transmission lines for R, G, and B, according to the control of the MPU 25. The image signal is delayed by the delay circuit 23, the skew thereof is adjusted, and the image signal is amplified by the amplifier 24. Then, the image signal is displayed on the display 40.

The MPU 25 communicates with the MPU 14 on the transmitting device 10, and requests for outputting the automatic adjusting signal to the LAN cable 100 in test mode. The gain of the receiver 21 and the frequency characteristic of the received signal are adjusted according to the attenuation amount of the automatic adjusting signal measured by the measuring circuit 22. The MPU 25 delays the RGB image signal according to the signal delay time of the respective transmission lines for R, G, and B, which are measured by the measuring circuit 22.

A description will now be given of adjusting methods of the gain, frequency characteristic, and skew. First, an adjusting method of the gain will be described. To adjust the gain, 1 MHz automatic adjusting signal, which is generated on the PLL circuit 11, is used. The transmitting device 10 generates the afore-mentioned 1 MHz automatic adjusting signal, and outputs the signal onto the transmission line in the LAN cable 100 by means of the driver 13. The signal transmitted on the transmission line is input into the voltage detection circuit, not shown, in the measuring circuit 22. The voltage detection circuit includes an A/D converter or the like, and detects the voltage of the automatic adjusting signal, which has been attenuated on the LAN cable 100. The automatic adjusting signal is a constant-voltage signal, and thereby is capable of measuring the cable length by measuring the attenuation amount of voltage.

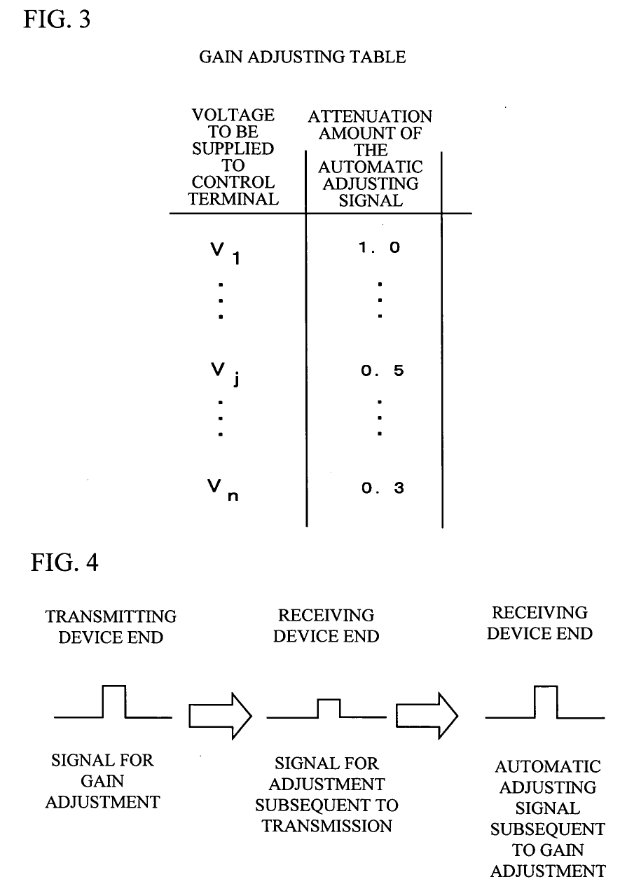

The MPU 25 stores a gain adjusting table as shown in FIG. 3. The cable length is measured by the attenuation amount and the voltage supplied to the gain control terminal of the receiver 21 is determined. The voltage is supplied to the gain control terminal of the receiver 21 by the D/A converter 26. The D/A converter 26 supplies a set voltage to the gain control terminal of the receiver 21 according to the control of the MPU 25. This makes it possible to adjust the gain of the receiver 21 and receive the signal having an appropriate gain as shown in FIG. 4.

The transmission lines are respectively provided for the image signals of R, G, and B. Therefore, the gain is adjusted on every transmission line of R, G, and B.

Next, a description will be given of the adjusting method of the frequency characteristic. 14 MHz and 90 MHz automatic adjusting signals are used for adjusting the frequency characteristic. The afore-mentioned automatic adjusting signals are output to the LAN cable 100 from the driver 13 of the transmitting device 10. The receiving device 20 measures the voltage of the received automatic adjusting signal with the use of the A/D converter, not shown, on the measuring circuit 22. This makes it possible to measure the attenuation amount on the LAN cable 100.

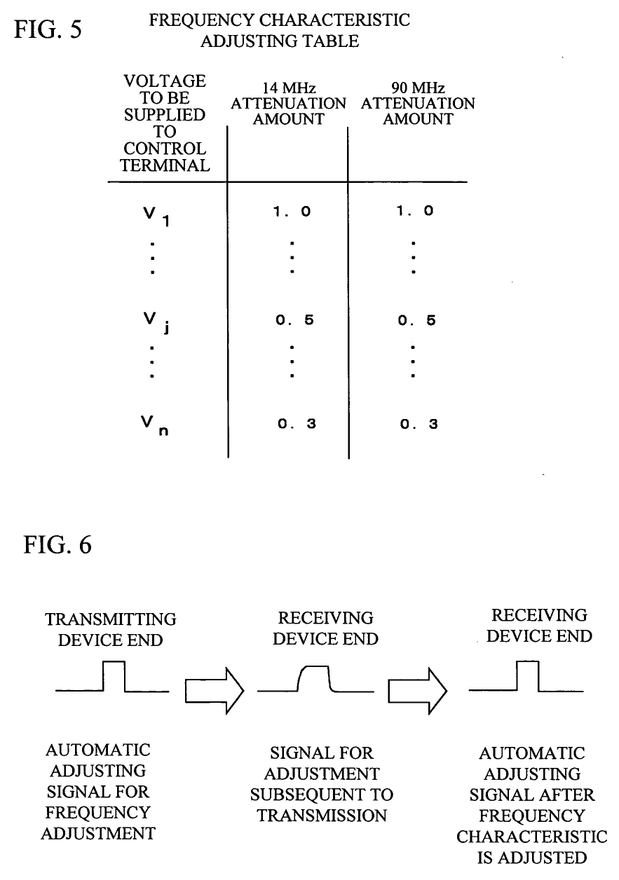

The MPU 25 stores a frequency characteristic adjusting table as shown in FIG. 5. Correction values of the frequency characteristic on higher and lower frequency sides are determined with the attenuation amount of the 14 MHz and 90 MHz automatic adjusting signals. The attenuation amounts are respectively measured on the transmission lines for R, G, and B, and the correction values are determined with the use of average values in the measurement results of the respective transmission lines. The correction value may be determined so that the 14 MHz and 90 MHz automatic adjusting signals to be used for adjusting the frequency characteristic may have the smallest difference in the attenuation amount.

The MPU 25 refers to the frequency characteristic adjusting table shown in FIG. 5, and determines the voltage supplied to the frequency characteristic adjusting terminal of the receiver 21. The voltage is supplied to the frequency characteristic adjusting terminal of the receiver 21 by means of the D/A converter 26. The D/A converter 26 supplies the set voltage to the frequency characteristic adjusting terminal of the receiver 21, according to the control of the MPU 25. This adjusts the equalizer, and the frequency characteristic of the received signal is improved as shown in FIG. 6.

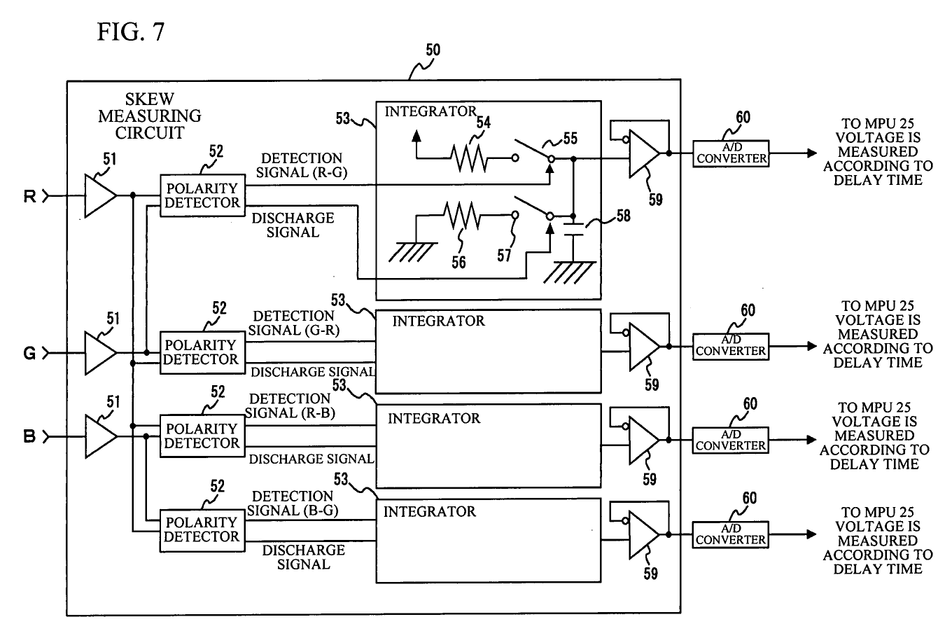

Next, a description will be given of the adjusting method of skew (delay time). First, referring to FIG. 7, a description will be given of the skew measuring circuit 50 that measures the skews of the image signals of R, G, and B. The measuring circuit 22 includes the skew measuring circuit 50 that measures the skew. The skew measuring circuit 50 includes an amplifier 51 that amplifies the input signal, a polarity detector 52 that detects the polarity of the signal to be measured, an integrator 53, and an operational amplifier 59.

The polarity detector 52 inputs any two of the image signals of R, G, and B. In other words, the polarity detector 52 is provided for inputting the image signals of R and G, G and R, R and B, or B and G. The image signals are compared with a predetermined threshold voltage. When the voltages of the signals are different, a detection signal is output. The polarity detector 52 outputs a discharge signal after a given period has passed since the detection signal was output to discharge a capacitor 58, as will be described later.

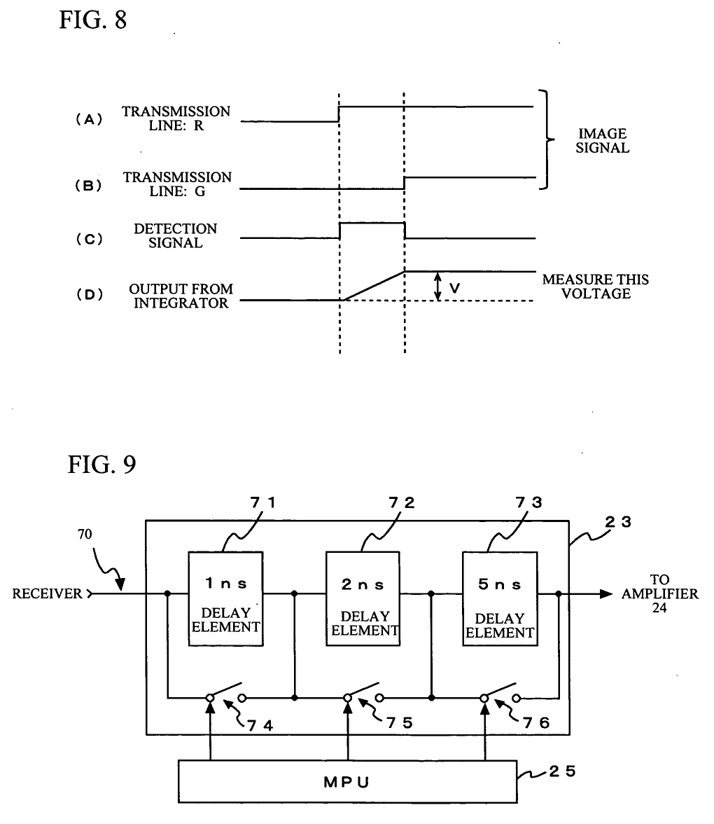

A description will be given, with reference to FIG. 8, of an operation of the integrator 53. For instance, the polarity detector 52, into which the image signals of R and G, are input, outputs the detection signal showing that the polarity has changed, and then turns on a switch 55 of the integrator 53, if there is a difference in the voltage between the image signals of R and G. If there is a difference in the arrival time of the image signals of R and G, as shown in (A) and (B) in FIG. 8, the polarity detector 52 outputs the detection signal of high level only for a time difference as shown in (C) in FIG. 8.

When the detection signal shifts to a high level, the switch 55 turns on. Then, the capacitor 58 is charged in the integrator 53 having a resistor 54 and the capacitor 58, as shown in (D) in FIG. 8. Accordingly, the integrator 53 integrates the time according to the difference in the arrival time of the image signals of R and G. An output from the integrator 53 is detected by an AD converter 60 via the operational amplifier 59 for impedance conversion, and is notified to the MPU 25. The capacitor 58 is discharged by the discharge signal, after a given period has passed.

Referring now to FIG. 9, a description will be given of a configuration and operation of the delay circuit 23. The MPU 25 delays the signal on the delay circuit 23 according to the amount of skew measured by the skew measuring circuit 50. The delay circuit 23 shown in FIG. 9 is provided on each of the signal lines of R, G, and B, and delays the signal according to the instruction of the MPU 25.

The delay circuit 23, referring to FIG. 9, includes multiple delay elements 71, 72, and 73, and switches 74, 75, and 76. The switches 74, 75, and 76 are provided for selectively changing the alternate route to output the signal without using the delay elements 71, 72, and 73. There are provided the delay elements for 1 ns, 2 ns, and 5 ns in accordance with the present embodiment, yet the present embodiment is not limited to the afore-mentioned examples and may have variations.

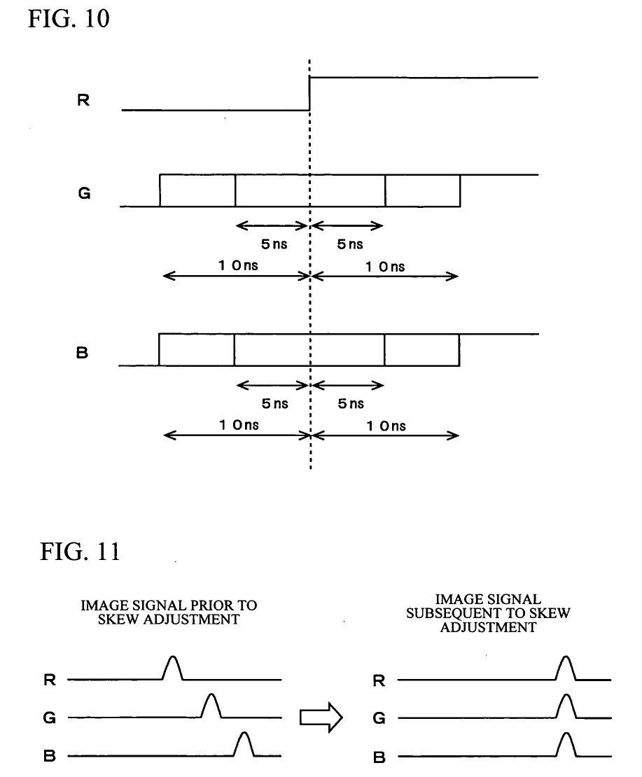

The MPU 25 predetermines one transmission line for a reference, and adjusts the signals on other transmission lines to have a delay of approximately +−5 ns or +−10 ns, relative to the signal of the reference transmission line, as shown in FIG. 10. For instance, when the signal is delayed only 5 ns relative to the signal of the reference transmission line, the switches 74 and 75 are turned on. Then, the signal is output after passing through the 5 ns delay element only. When the signal on the reference transmission line is 10 ns delayed and the signals on another transmission line is delayed 5 ns, it is possible to output the signal on another transmission line earlier than that on the reference transmission line. In this manner, it is possible to output the signal that is delayed a given period, by controlling on/off of the switches 74, 75, and 76, with the MPU 25.

The skews occurring between the signals on the transmission lines of R, G, and B are measured as described above. This enables to correct the misalignments of the signals of R, G, and B, as shown in FIG. 11. It is therefore possible to display high-quality images without generating the color drift on the display 40.

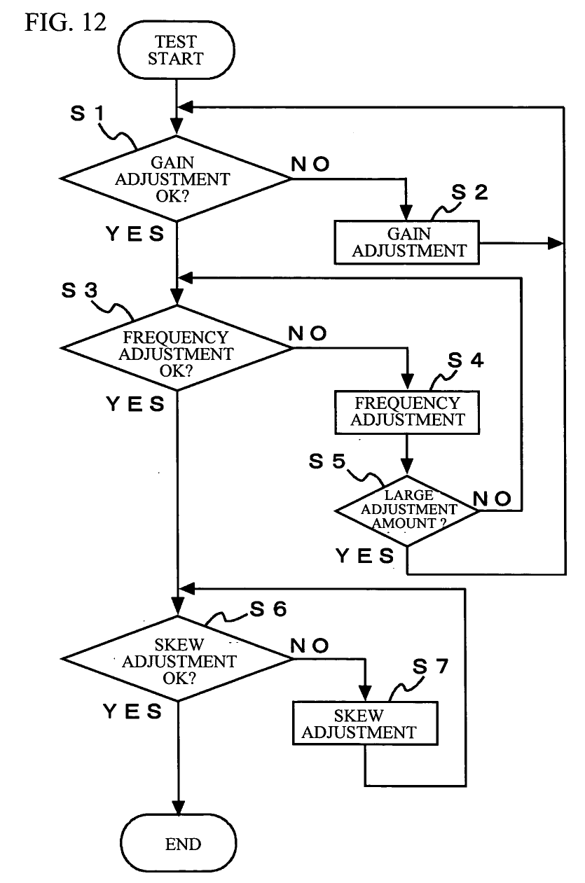

Referring now to a flowchart shown in FIG. 12, a description will be given of an operation procedure in test mode. The keyboard/mouse 41 shown in FIG. 1 is set to a test mode according to a switch setting. Then, the MPU 25 on the receiving device 20 notifies the MPU 14 on the transmitting device 10 of the test mode, and requests for sending the automatic adjusting signal. The MPU 14 on the transmitting device 10 outputs the automatic adjusting signal of a designated frequency to the LAN cable 100 by means of the driver 13. The MPU 25 on the receiving device 20 receives the automatic adjusting signal on the receiver 21, and measures the attenuation amount of the signal with the measuring circuit 22. The MPU 25 obtains the cable length of the LAN cable 100 with the measured attenuation amount, and adjusts the gain of the receiver 21 (step S2). The gain is adjusted by referring to the gain adjusting table shown in FIG. 3. The MPU 25 obtains the voltage supplied to the gain control terminal of the receiver 21 with the attenuation amount of the automatic adjusting signal, and the corresponding voltage is supplied by the D/A converter 26. The gain is adjusted on every transmission line of R, G, and B.

The gain adjustment is completed (step 1/YES), and the frequency characteristic is adjusted (step S3). The transmitting device 10 transmits the signal for adjusting the frequency characteristic, and the receiving device 20 measures the attenuation amount of the signal on the measuring circuit 22 thereof. In accordance with the present embodiment, 14 MHz and 90 MHz signals are used for measuring the frequency characteristic of the signal. The MPU 25 obtains the cable length of the LAN cable 100 with such measured attenuation amount, and corrects the frequency characteristic of the received signal (step S3). The frequency characteristic is adjusted by referring to the frequency characteristic adjusting table shown in FIG. 5. The MPU 25 obtains the voltage to be supplied to the frequency characteristic control terminal of the receiver 21 with the attenuation amount of the automatic adjusting signal, and supplies the corresponding voltage from the D/A converter 26 (step S4). The frequency characteristic is adjusted by obtaining the average value of the attenuation amounts measured on the respective transmission lines of R, G, and B, and the corresponding correction value is obtained from the frequency characteristic adjusting table.

The frequency characteristic adjustment is completed (step S5). Then, the adjustment amount of the frequency characteristic is determined whether it is greater than a given value (step S5). If the adjustment amount of the frequency characteristic is greater than the given value (step S5/YES), it is determined that this adjustment also changes the gain adjustment amount. Therefore, the gain is adjusted again (step S1). If the adjustment amount of the frequency characteristic is smaller than the given value (step S5), it is determined that the frequency characteristic adjustment is completed (step S3) and the skew is adjusted (step S7).

In adjusting the skew (step S7), the automatic adjusting signals are output to the respective transmission lines of R, G, and B, and then the receiving device 20 measures the signal delay times of the respective transmission lines on the receiving device 20. The signals of the corresponding transmission lines are delayed and output to correspond to the measured delay times. The skew adjustment is completed (step S6/YES), and then the test mode is completed.

Referring now to a flowchart shown in FIG. 13, a description will be given of the procedure of an automatic adjustment mode. In the automatic adjustment mode, the gain adjusting table and the frequency characteristic adjusting table are rewritten by the user's operation and input, while the display 40 is displaying the image for adjustment. The user inputs an instruction of changing the gain (step S11/YES), it is determined whether the setting value on the gain adjusting table is increased (step S12) or decreased (step S13) according to the input. Then, the gain adjusting table is rewritten according to the judgment result (step S14). In the same manner, the user inputs an instruction of changing the frequency characteristic (step S15/YES), it is determined whether the setting value on the frequency characteristic adjusting table is increased (step S12) or decreased (step S13) according to the input. Then, the frequency characteristic adjusting table is rewritten according to the judgment result (step S14).

In the present embodiment, it is possible to adjust the gain, frequency characteristic, skew automatically as well as manually, making it possible to adjust the image quality according to the user's desire.

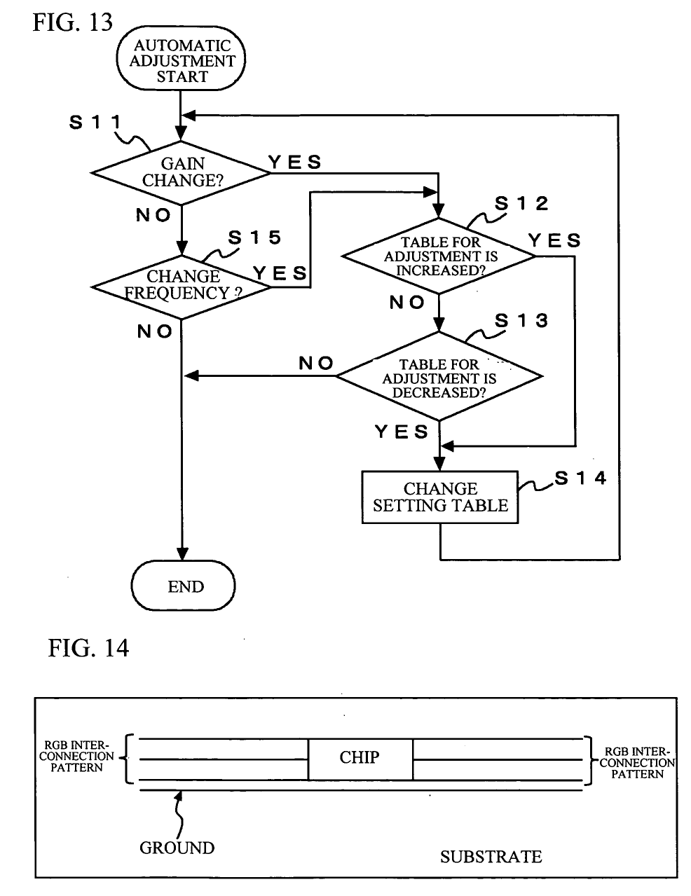

FIG. 14 shows a configuration in which the transmitting device 10 or the receiving device 20 is composed of a semiconductor chip provided on a substrate. The signal interconnections of R, G, and B are provided on the substrate to have given widths, for example, 0.5 mm or 0.8 mm. Here, the signal interconnections of R, G, and B are provided without a change in the pattern widths thereof even partially. Also, the signal interconnections are provided so that the gap between the ground patterns may be uniform, for example, 0.3 mm or more in accordance with the present embodiment. The pattern formed in this manner prevents the signal reflection, making it possible to display the images of higher resolution on the display 40.

### Second Embodiment

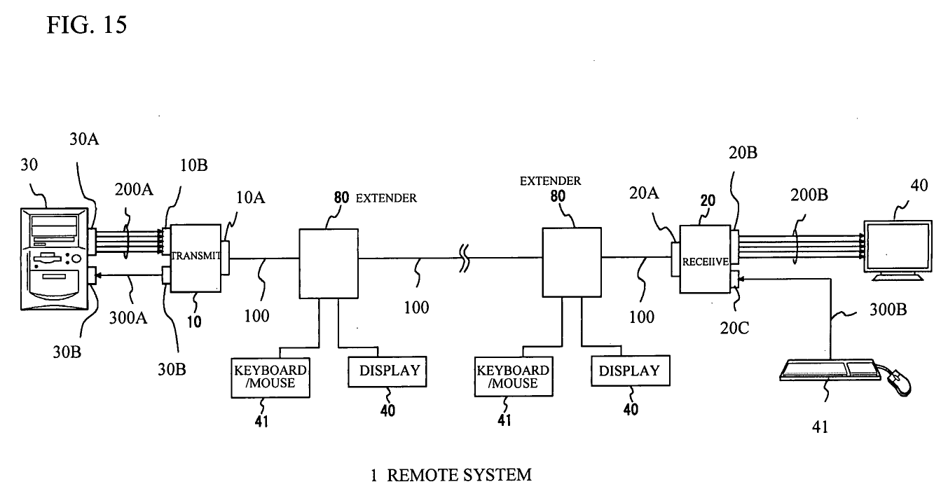

A second embodiment of the present invention will be described below, with reference to the drawings. Referring to FIG. 15, multiple extenders 80 are provided between the transmitting device 10 and the receiving device 20 to extend the transmission distance of the signals. The signals output from the transmitting device 10 are degraded depending on the transmission distance. Therefore, the extenders 80 are provided to restore the degraded signals to output to the adjacent extender 80 or the receiving device 20. The receiving end is able to receive the optimal signals with less degradation, because the degraded transmission signals, being corrected by the extender 80, are transmitted to the receiving device 20. The display 40 and the keyboard/mouse 41 are connected to the extender 80. Accordingly, it is possible to display the image signal after the extender 80 receives the image signal transmitted from the server 30. It is possible to operate the server 30 on the extender 80 by operating the keyboard/mouse 41. For this reason, a driver circuit is provided on the extender 80 so as to input the operation information of the keyboard/mouse 41 and output to the LAN cable 100 on the side of the server 30. In the same manner, the transmitting device 10 includes the receiver or the like that receives the operation information transmitted via the LAN cable 100, and the received operation information is output to the server 30 via the cable 300A.

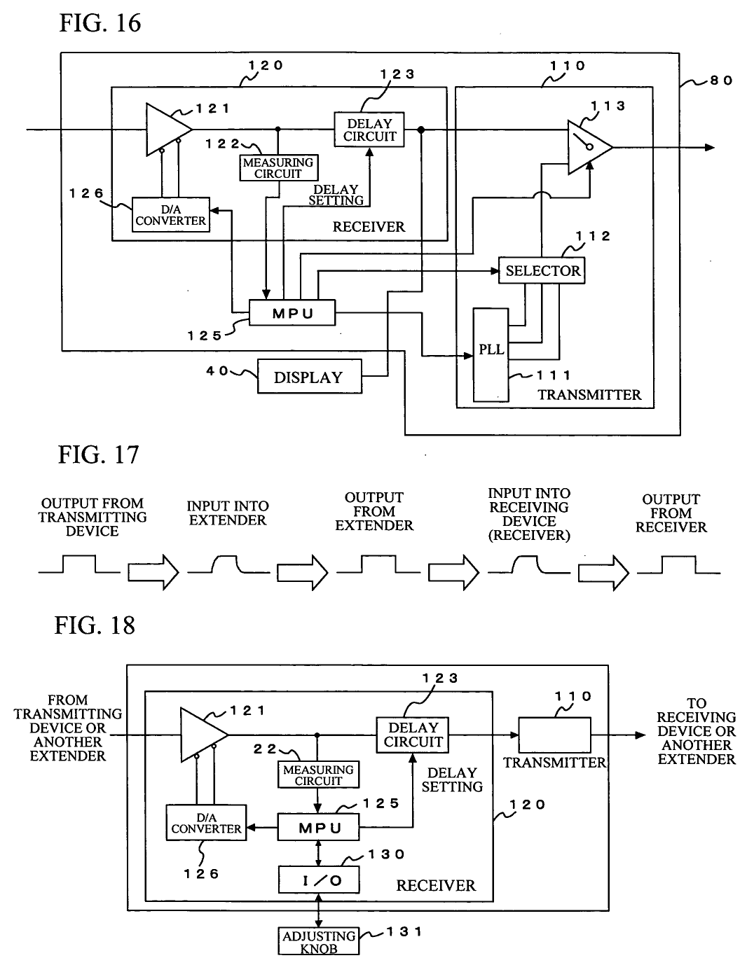

FIG. 16 shows a configuration of the extender 80. The extender 80 in FIG. 16 shows only a portion relating to the transmission of the image signal from the server 30 to the display 40, and does not show a portion relating to the signal transmission from the keyboard/mouse 41 to the server 30. The extender 80 in FIG. 16 includes a transmitter 110 and a receiver 120. The transmitter 110 corresponds to the transmitting device 10 in accordance with the first embodiment of the present invention. The receiver 120 corresponds to the receiving device 20 in accordance with the first embodiment of the present invention. A detailed description on the functionalities thereof is omitted, because the functionalities thereof are same as those in accordance with the first embodiment. The extender 80 controls both the transmitter 110 and the receiver 120 with an MPU 125. The MPUs may be provided for controlling the transmitter 110 and the receiver 120 respectively.

FIG. 17 shows an output waveform of the transmitting device 10, an input waveform of the extender 80, an output waveform of the extender 80, an input waveform of the receiver 21 of the receiving device 20, and a signal having a waveform adjusted on the receiving device 20. The signal output into the LAN cable 100 from the transmitting device 10 is degraded as the transmission distance becomes longer. This degradation of the waveform is restored on the extender 80 provided on the transmission path, and such restored waveform is output to the next extender 80 or the receiving device 20. The extender 80 has the functionalities of correcting the gain, frequency characteristic, and skew of the signal as described above, enabling to restore the degraded signal to the original one. In this manner, it is possible to extend the transmission distance of the signal.

The extender 80 shown in FIG. 16 automatically corrects the gain, frequency characteristic, and skew with the MPU 125. However, for instance, an adjusting knob 131 may be provided as shown in FIG. 18 to manually adjust the gain, skew, and the like. A measuring circuit 122 detects the voltage for automatic adjusting signal, and then the MPU 125 displays the detected voltage on a display portion, not shown. The user adjusts the adjusting knob 131 with the attenuation amount of the voltage shown on the display portion for an optimal value.

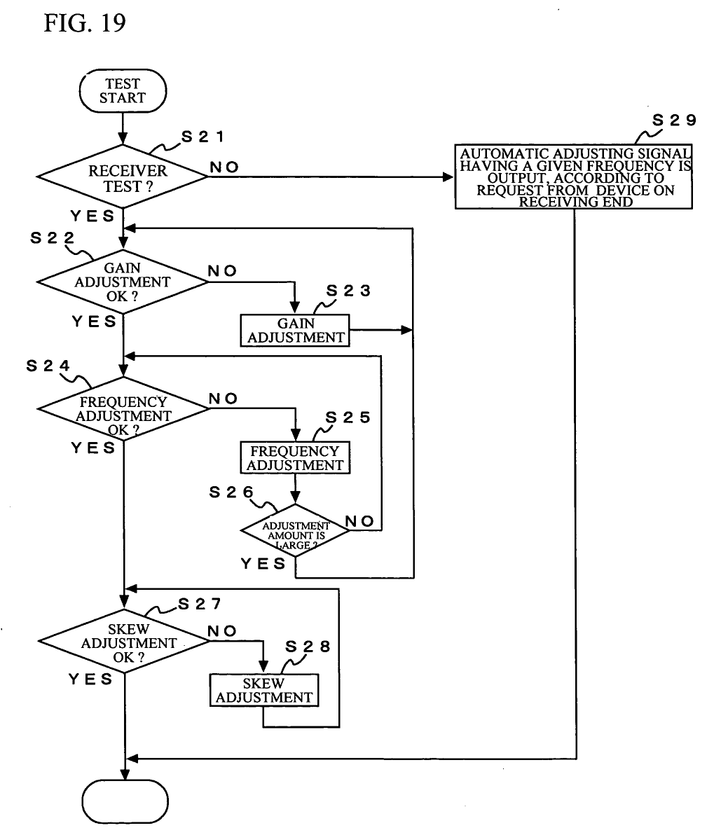

A description will now be given of an operation procedure of the extender 80 in test mode, with reference to FIG. 19. First, the receiver 120 of the extender 80 is tested (step S21/YES). The MPU 125 of the extender 80 notifies the test mode of the extender 80 or the transmitting device 10 provided in the upstream, and requests for sending the automatic adjusting signal. The MPU 14 on the transmitting device 10 or the MPU 125 on the extender 80 output the automatic adjusting signals having a designated frequency to the LAN cable 100 with the drivers 13 and 113.

The MPU 125 on the extender 80 receives the automatic adjusting signal on a receiver 121, and measures the attenuation amount of the signal on the measuring circuit 122. The MPU 125 obtains the cable length of the LAN cable 100 with such measured attenuation amount to adjust the gain of the receiver 121 (step S23). The MPU 125 obtains the voltage to be supplied to the gain control terminal of the receiver 121 with the attenuation amount of the automatic adjusting signal, and supplies the corresponding voltage from a D/A converter 126. The gain is adjusted on every transmission line of R, G, and B.

The gain adjustment is completed (step S22/YES), and then the frequency characteristic is adjusted (step S24). The signal for adjusting the frequency characteristic is transmitted from the transmitting device 10, and the attenuation amount of the signal is measured on the measuring circuit 22 of the receiving device 20. The MPU 125 obtains the cable length of the LAN cable 100 with such measured attenuation amount, and corrects the frequency characteristic of the received signal (step S25). The average value of the attenuation amounts measured on every transmission line of R, G, and B is obtained for adjusting the frequency characteristic, and the corresponding correction value is obtained from the frequency characteristic adjusting table.

The frequency characteristic adjustment is completed (step S25), and then it is determined whether the adjustment amount of the adjusted frequency characteristic is greater than a given value (step S26) . If the adjustment amount of the frequency characteristic is greater than the given value (step S26/YES), it is determined that this adjustment also changes the adjustment amount of the gain. Therefore, the gain is adjusted again (step S22). If the adjustment amount of the frequency characteristic is smaller than the given value (step S25/NO), it is determined that the frequency characteristic adjustment is completed (step S24/YES) and the skew is adjusted (step S27).

In adjusting the skew (step S27), the automatic adjusting signals are output to the respective transmission lines of R, G, and B, and then the receiving device 20 measures the signal delay times of the respective transmission lines. The signals of the corresponding transmission lines are delayed and output to correspond to such measured delay times. The skew adjustment is completed (step S27/YES), and then the test mode is completed.

The adjustment of the receiver 120 is completed, and then the automatic adjusting signal having a given frequency is output, according to the request from either the extender 80 provided in a later stage or the receiving device 20, so as to test the extender 80 provided in a later stage or the receiving device 20 (step S29). The device provided in the later stage is tested by using the automatic adjusting signal giving a given frequency.

In accordance with the present embodiment, multiple extenders 80 are provided between the transmitting device 10 and the receiving device 20. The extender 80 implements the restoration process of the degraded signal, extending the transmission distance of the signal, and allowing the user to operate the server 30 remotely.

A display portion such as LED or the like may be provided on the extender 80 so that the display portion may indicate that there is something wrong with the communication, if any, by monitoring the communication of the LAN cable 100, yet the display portion is not shown in FIG. 16. When the power is supplied to the extender 80 from an external power supply, the LED may be illuminated to indicate that there is something wrong with the power supply, if any, by monitoring the power supply.

The remote system may further include a display monitor that displays the image signal or the automatic adjusting signal received by the receiving portion; and a gain adjusting table that stores values for adjusting the gain, according to the length of the cable. The control portion may rewrite the gain adjusting table by a given input operation while the display monitor is displaying the automatic adjusting signal. Therefore, it is possible to adjust the gain of the receiving portion while viewing the image displayed on the display monitor.

The remote system may further include a display monitor that displays the image signal or the automatic adjusting signal received by the receiving portion; and a frequency characteristic adjusting table that stores correction values to correct the frequency characteristic so that the frequency characteristic of the signal received by the receiving portion is optimal according to the length of the cable. The frequency characteristic adjusting table may be rewritten by a given input operation while the display monitor is displaying the automatic adjusting signal. Therefore, it is possible to adjust the frequency characteristic of the receiving portion while viewing the image displayed on the display monitor.

The present invention is not limited to the above-mentioned embodiments, and other embodiments, variations and modifications may be made without departing from the scope of the present invention. For instance, the remote unit is provided to correct the gain, frequency characteristic, and skew, as described above. However, one or two of the gain, frequency characteristic, and skew may be adjusted. In addition, two extenders 80 are provided in the second embodiment of the present invention. However, the number of the extenders 80 is not limited to this. Appropriate number of the extenders 80 may be provided according to the transmission distance of the signal.

The present invention is based on Japanese Patent Application No. 2004-341960 filed on Nov. 26, 2004, and Japanese Patent Application No. 2005-005782 filed on Jan. 12, 2005, the entire disclosure of which is hereby incorporated by reference.

What is claimed is:

1. A remote unit that is connected to a server with a cable, and receives and displays an image signal transmitted from the server, the remote unit comprising:
a receiving portion that receives a signal transmitted via the cable and adjusts a gain of the signal;
a voltage detection portion that receives an automatic adjusting signal for adjusting the gain and detects a received voltage of the signal; and
a control portion that obtains a length of the cable with the received voltage and adjusts the gain of the receiving portion with the length obtained.

2. A remote unit that is connected to a server with a cable, and receives and displays an image signal transmitted from the server, the remote unit comprising:
a receiving portion that receives a signal transmitted via the cable and adjusts a frequency characteristic of the signal;
a voltage detection portion that receives an automatic adjusting signal for adjusting the frequency characteristic and detects a received voltage of the signal; and
a control portion that obtains a length of the cable with the received voltage and controls the receiving portion to obtain the frequency characteristic that is desirable.

3. A remote unit that is connected to a server with a cable, and receives and displays an image signal transmitted from the server, the remote unit comprising:
a receiving portion that receives signals of multiple signal lines included in the cable;
a delay time measuring portion that measures a delay time between the signals of said multiple signal lines; and
a signal delay portion that delays and outputs a corresponding signal according to the delay time.

4. The remote unit as claimed in claim 1, wherein:
the receiving portion includes a portion that adjusts a frequency characteristic of a signal; and
the control portion obtains the length of the cable with the received voltage and controls the receiving portion to obtain the frequency characteristic that is desirable.

5. The remote unit as claimed in claim 1, further comprising:
a delay time measuring portion that measures a delay time between signals of multiple signal lines included in the cable; and
a signal delay portion that delays and outputs a corresponding signal according to the delay time.

6. The remote unit as claimed in claim 1, wherein the control portion includes a gain adjusting table that stores values for adjusting the gain, according to the length of the cable.

7. The remote unit as claimed in claim 2, wherein the control portion includes a frequency characteristic adjusting table that stores correction values to correct the frequency characteristic so that the frequency characteristic of the signal received by the receiving portion is optimal according to the length of the cable.

8. The remote unit as claimed in claim 1, wherein:
the cable includes multiple signal lines; and
the gain of receiving portion is adjusted on each of said multiple signal lines.

9. The remote unit as claimed in claim 2, wherein:
the cable includes multiple signal lines; and
the frequency characteristic of the signal is adjusted on each signal transmitted on said multiple signal lines.

10. The remote unit as claimed in claim 3, wherein:
the image signal includes three image signals of R, G, and B; and
the signal delay portion predetermines one of the three image signals as a reference to adjust delay times of the other two image signals or selectively change delay elements respectively provided on said multiple signal lines to adjust the delay times of the image signals.

11. A remote system comprising:
a transmitting device that outputs an image signal output from a server to a cable; and
a receiving device that is connected to the transmitting device via the cable and receives the image signal,
wherein:
the transmitting device includes a transmitting portion that outputs an automatic adjusting signal;
the receiving device includes:
a receiving portion that receives a signal transmitted via the cable and adjusts the gain of the signal;
a voltage detection portion that detects a received voltage of the automatic adjusting signal for adjusting the gain; and
a control portion that obtains a length of the cable with the received voltage and adjusts the gain of the receiving portion with the length obtained.

12. A remote system comprising:
a transmitting device that outputs an image signal output from a server to a cable; and
a receiving device that is connected to the transmitting device via the cable and receives the image signal,
wherein:
the transmitting device includes a transmitting portion that outputs an automatic adjusting signal for adjusting a frequency characteristic;
the receiving device includes:
a receiving portion that receives a signal transmitted via the cable and adjusts the frequency characteristic of the signal;
a voltage detection portion that detects a received voltage of the automatic adjusting signal; and
a control portion that obtains a length of the cable with the received voltage and adjusts the gain of the receiving portion with the length obtained.

13. A remote system comprising:
a transmitting device that outputs an image signal output from a server to a cable; and
a receiving device that is connected to the transmitting device via the cable and receives the image signal,
wherein the receiving device includes:
a receiving portion that receives signals transmitted on multiple signal lines included in the cable;
a delay time measuring portion that measures a delay time between the signals of said multiple signal lines; and
a signal delay portion that delays and outputs a corresponding signal according to the delay time.

14. The remote system as claimed in claim 11, further comprising:
a display monitor that displays the image signal or the automatic adjusting signal received by the receiving portion; and
a gain adjusting table that stores values for adjusting the gain, according to the length of the cable,
wherein the control portion rewrites the gain adjusting table by a given input operation while the display monitor is displaying the automatic adjusting signal.

15. The remote system as claimed in claim 12, further comprising:
a display monitor that displays the image signal or the automatic adjusting signal received by the receiving portion; and
a frequency characteristic adjusting table that stores correction values to correct the frequency characteristic so that the frequency characteristic of the signal received by the receiving portion is optimal according to the length of the cable,
wherein the frequency characteristic adjusting table is rewritten by a given input operation while the display monitor is displaying the automatic adjusting signal.

16. An extender provided on a transmission line to relay a signal, the extender comprising:
a receiving portion that receives the signal and adjusts a gain of the signal;
a voltage detection portion that detects a received voltage of an automatic adjusting signal for adjusting the gain; and
a control portion that obtains a length of the cable with the received voltage and adjusts the gain of the receiving portion with the length of the cable obtained.

17. An extender provided on a transmission line to relay a signal, the extender comprising:
a receiving portion that receives the signal and adjusts a frequency characteristic of the signal;
a voltage detection portion that detects a received voltage of an automatic adjusting signal for adjusting the frequency characteristic; and
a control portion that measures a length of the cable with the received voltage, controls the receiving portion according to the length of the cable obtained, and obtains the frequency characteristic that is desirable.

18. An extender provided on a transmission line to relay a signal, the extender comprising:
a receiving portion that receives signals of multiple signal lines included in the cable;
a delay time measuring portion that measures a delay time between the signals of said multiple signal lines; and
a signal delay portion that outputs a corresponding signal according to the delay time.

19. The extender as claimed in claim 16, wherein:
the receiving portion includes a portion that adjusts a frequency characteristic of a signal; and
the control portion obtains the length of the cable with the received voltage and controls the receiving portion to obtain the frequency characteristic that is desirable.

20. The extender as claimed in claim 16, further comprising:
a delay time measuring portion that receives signals of multiple signal lines included in the cable and measures a delay time between signals of multiple signal lines included in the cable; and
a signal delay portion that delays and outputs a corresponding signal according to the delay time.

21. The extender as claimed in claim 16, further comprising a transmitting portion that outputs the automatic adjusting signal to a device provided in a later stage of the transmission line.

22. The extender as claimed in claim 16, wherein the control portion includes a gain adjusting table that stores values for adjusting the gain, according to the length of the cable measured.

23. The extender as claimed in claim 17, wherein the control portion includes a frequency characteristic adjusting table that stores correction values to correct the frequency characteristic so that the frequency characteristic of the signal received is optimal according to the length of the cable.

24. The extender as claimed in claim 18, wherein:
the image signal includes three image signals of R, G, and B; and
the signal delay portion set one of the three image signals as a reference to adjust delay times of the other two image signals or selectively change delay elements respectively provided on said multiple signal lines to adjust the delay times of the image signals.

25. A remote system comprising:
a transmitting device that outputs an image signal output from a server to a cable;
a receiving device that is connected to the transmitting device via the cable and receives the image signal; and
an extender provided on a transmission line to relay a signal,
wherein the receiving device includes:
a first receiving portion that receives signals transmitted on multiple signal lines included in the cable;
a first delay time measuring portion that measures a delay time between the signals of said multiple signal lines; and
a first signal delay portion that outputs a corresponding signal according to the delay time,
wherein the extender includes:
a second receiving portion that receives the signals of multiple signal lines included in the cable;
a second delay time measuring portion that measures the delay time between the signals of said multiple signal lines; and
a second signal delay portion that delays and outputs the corresponding signal according to the delay time.

26. The remote system as claimed in claim 25, further wherein:
the extender further includes:
a connector that connects a console device provided to operate a server that supplies the image signal; and
a transmitting portion that transmits operation information to the server, the operation information being input by the console device and transmitted from the extender or the receiving device.

27. An automatic adjusting method comprising:
receiving on a receiving portion an automatic adjusting signal transmitted on a cable;
detecting a received voltage of the automatic adjusting signal received via the cable; and
measuring a length of the cable with the received voltage and adjusting a gain of the receiving portion on the basis of the length of the cable measured.

28. An automatic adjusting method comprising:
receiving on a receiving portion an automatic adjusting signal transmitted on a cable;
detecting a received voltage of the automatic adjusting signal received via the cable; and
measuring a length of the cable with the received voltage and controlling the receiving portion to obtain a desired frequency characteristic on the basis of the length of the cable measured.

29. An automatic adjusting method comprising:
receiving signals transmitted on multiple signal lines;
measuring delay times between the signals transmitted on said multiple signal lines; and
delaying and outputting a corresponding signal according to the delay times.
